(19) United States
(12) Patent Application Publication
(10) Pub. No.: US 2014/0169743 A1
(43) Pub. Date: Jun. 19, 2014

(54) FERRULE ASSEMBLY WITH LATERAL FIBER INSERTION

(71) Applicants: Malcolm H. Hodge, Chicago, IL (US); Wenzong Chen, Naperville, IL (US); Dean Richardson, Wilmette, IL (US); Scot A. Ernst, Plainfield, IL (US); Thomas D. Schiltz, Naperville, IL (US); Thomas R. Marrapode, Naperville, IL (US)

(72) Inventors: Malcolm H. Hodge, Chicago, IL (US); Wenzong Chen, Naperville, IL (US); Dean Richardson, Wilmette, IL (US); Scot A. Ernst, Plainfield, IL (US); Thomas D. Schiltz, Naperville, IL (US); Thomas R. Marrapode, Naperville, IL (US)

(73) Assignee: Molex Incorporated, Lisle, IL (US)

(21) Appl. No.: 14/123,539

(22) PCT Filed: Jun. 14, 2012
(86) PCT No.: PCT/US2012/042428

§ 371 Date: Feb. 28, 2014

Related U.S. Application Data
(60) Provisional application No. 61/496,715, filed on Jun. 14, 2011.

(51) Int. Cl. G02B 6/40

(52) U.S. Cl. CPC G02B 6/403
USPC 385/54

(57) ABSTRACT

An optical fiber ferrule assembly includes a ferrule body with an optical fiber receiving nest configured to receive a plurality of optical fibers. The nest opens laterally relative to the optical fiber axis to facilitate insertion of the optical fibers into the optical fiber receiving nest. The nest includes a plurality of arcuate surfaces configured to engage and align the optical fibers. A cover is secured to the ferrule body to secure the optical fibers within the optical fiber receiving nest. A ferrule and a method of assembly are also provided.

### REFERENCE To RELATED APPLICATIONS

The Present Disclosure claims priority to prior-filed U.S. Provisional Patent Application No. 61/496,715, entitled “Paroli-Type Ferrule Assembly,” filed on 14 Jun. 2011 with the United States Patent And Trademark Office. The content of the aforementioned Patent Application is incorporated in its entirety herein.

### BACKGROUND OF THE PRESENT DISCLOSURE

The Present Disclosure relates, generally, to optical fiber ferrule assemblies and, more particularly, to a multi-fiber ferrule assembly with an optical fiber receiving nest configured for lateral insertion of optical fibers.

Systems for interconnecting optical fibers typically utilize mating ferrule assemblies to facilitate handling and accurate positioning of the fibers. Glass optical fibers are typically secured within holes that extend through the body of the ferrule with an end surface of each fiber being positioned generally flush with or slightly protruding from an end face of the ferrule body. When complementary ferrules assemblies are mated, each optical fiber of one ferrule assembly is aligned with a mating optical fiber of the other ferrule assembly.

Plastic optical fibers have increasingly been used in place of glass optical fibers as the transmission speeds of plastic optical fibers have increased and transmission distances have increased. Termination and handling of plastic optical fibers present additional and different challenges as compared to glass optical fibers due to the characteristics and size of the plastic optical fibers. For example, plastic optical fibers are typically very flexible and may be easily deformed which can affect their light transmission characteristics. It is desirable to provide a multi-fiber ferrule assembly that may be used to terminate plastic optical fibers in a more efficient manner and that results in a smaller ferrule assembly.

### SUMMARY OF THE PRESENT DISCLOSURE

In one aspect an optical fiber ferrule assembly includes a plurality of generally parallel optical fibers. A ferrule body has a front face and an oppositely facing rear face. The ferrule body has an optical fiber receiving nest configured to receive a plurality of generally aligned optical fibers with the axes of the optical fibers being generally parallel to an optical fiber axis. The optical fiber receiving nest opens laterally relative to the optical fiber axis to facilitate insertion of the optical fibers into the optical fiber receiving nest. The optical fiber receiving nest has an optical fiber registration surface with a plurality of arcuate surfaces, each arcuate surface being configured to engage one of the optical fibers for aligning the optical fibers relative to the optical fiber axis. A cover is secured to the ferrule body to secure the optical fibers within the optical fiber receiving nest.

In another aspect, an optical fiber ferrule includes a ferrule body having a front face and an oppositely facing rear face. The ferrule body further includes an optical fiber receiving nest extending generally between the front face and the rear face and being configured to receive a plurality of generally aligned optical fibers with axes of the optical fibers being generally parallel to an optical fiber axis. The optical fiber receiving nest has an optical fiber registration surface including a plurality of arcuate surfaces, each arcuate surface being configured to engage one of the optical fibers. The optical fiber registration surface opens laterally relative to the optical fiber axis to facilitate lateral insertion of the optical fibers into the optical fiber receiving nest.

In still another aspect, a method of assembling an optical fiber ferrule assembly includes providing a ferrule body having a front face, an oppositely facing rear face and an optical fiber receiving nest positioned between the front face and the rear face. The optical fiber receiving nest has an optical fiber registration surface including a plurality of arcuate channels extending generally between the front face and the rear face. An optical fiber is aligned with each of the arcuate channels. The optical fibers are moved into the optical fiber receiving nest opening and laterally against the plurality of arcuate surfaces to form a generally parallel array of optical fibers. The array of optical fibers are secured within the optical fiber receiving nest.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 is a perspective view of an embodiment of a terminated ferrule assembly;

FIG. 2 is an exploded perspective view of the ferrule assembly of FIG. 1;

FIG. 3 is a section taken generally along Line 3-3 of FIG. 1;

FIG. 4 is a section taken generally along Line 4-4 of FIG. 1;

FIG. 5 is a front view of FIG. 2 but depicting only the ferrule body, one array of optical fibers and one cover;

FIG. 6 is a front view of an alternate embodiment of a ferrule body with optical fibers spaced therefrom;

FIG. 7 is a front view of another alternate embodiment of a ferrule body with optical fibers spaced therefrom;

FIG. 8 is a section similar to FIG. 3, but of an alternate embodiment;

FIG. 9 is a front view similar to FIG. 5, but depicting the alternate embodiment;

FIG. 10 is a view similar to FIG. 8, but with the arrays of optical fibers including a connecting member;

FIG. 11 is diagrammatic view of a fixture and an array of optical fibers;

FIG. 12 is a view similar to FIG. 11, but with the array of optical fibers inserted into the fixture and with a conformal coating applied to the array;

FIG. 13 is a view similar to FIG. 12, but with the conformal coating evenly distributed over the array; and

FIG. 14 is a view similar to FIG. 13, but with the array being removed from the fixture.

### DESCRIPTION OF THE PREFERRED EMBODIMENTS

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

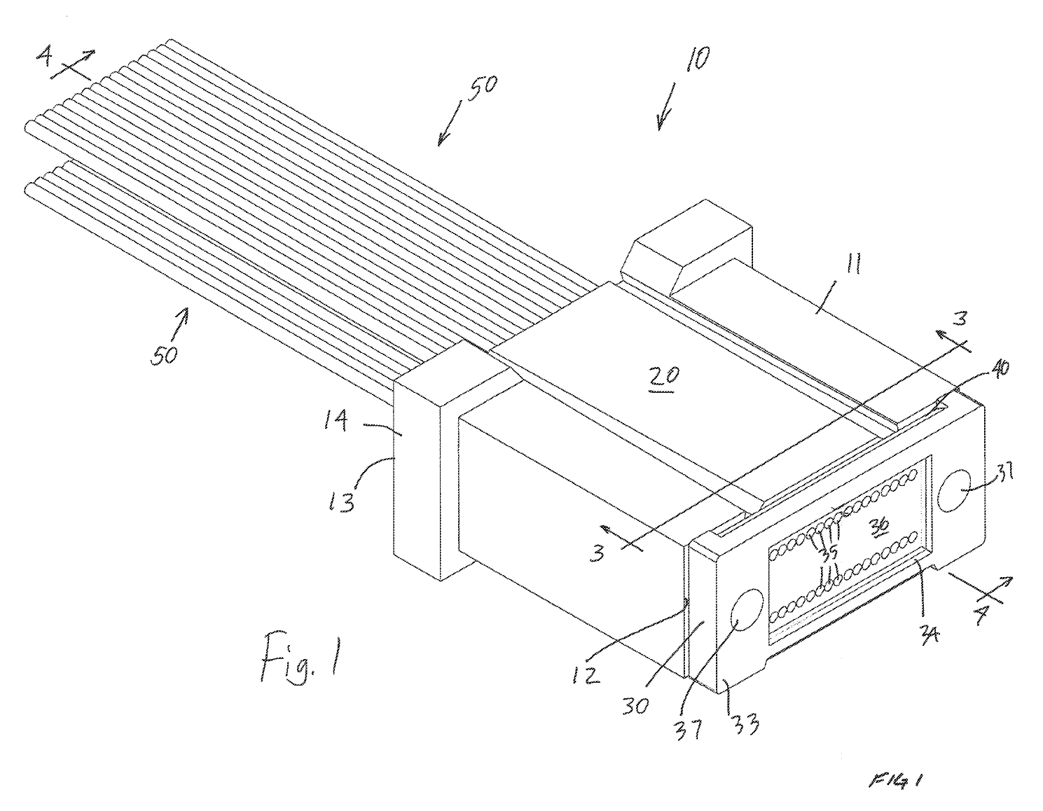

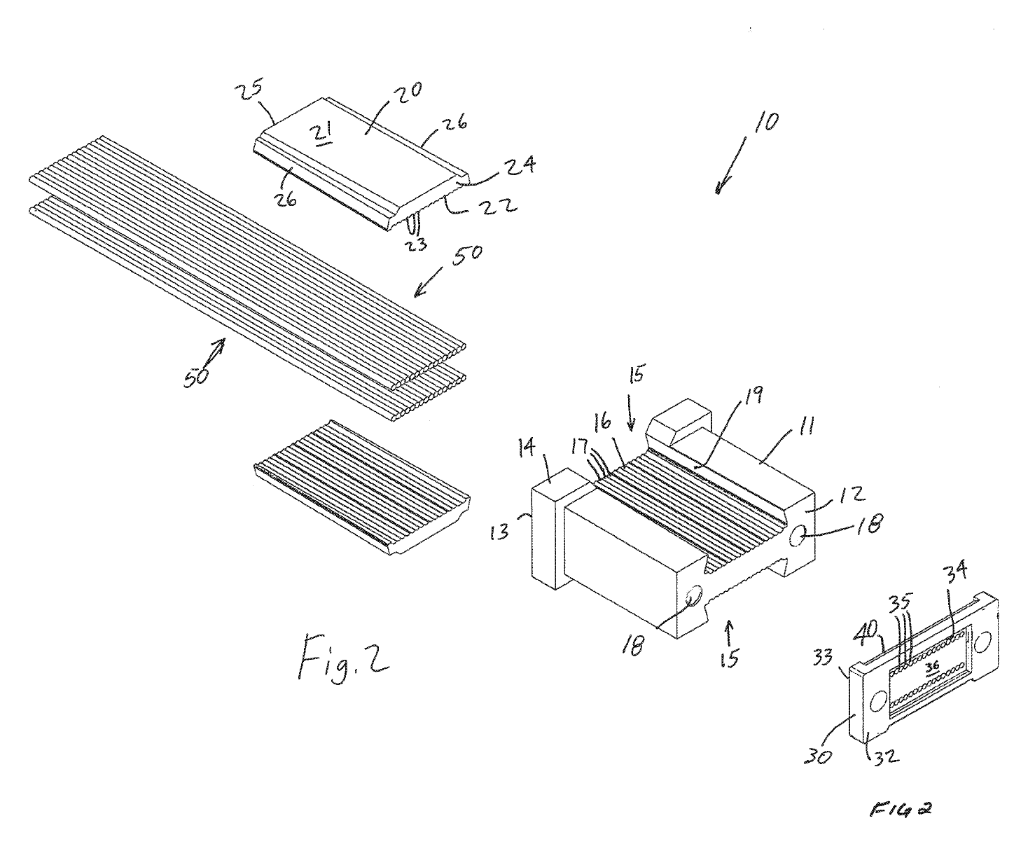

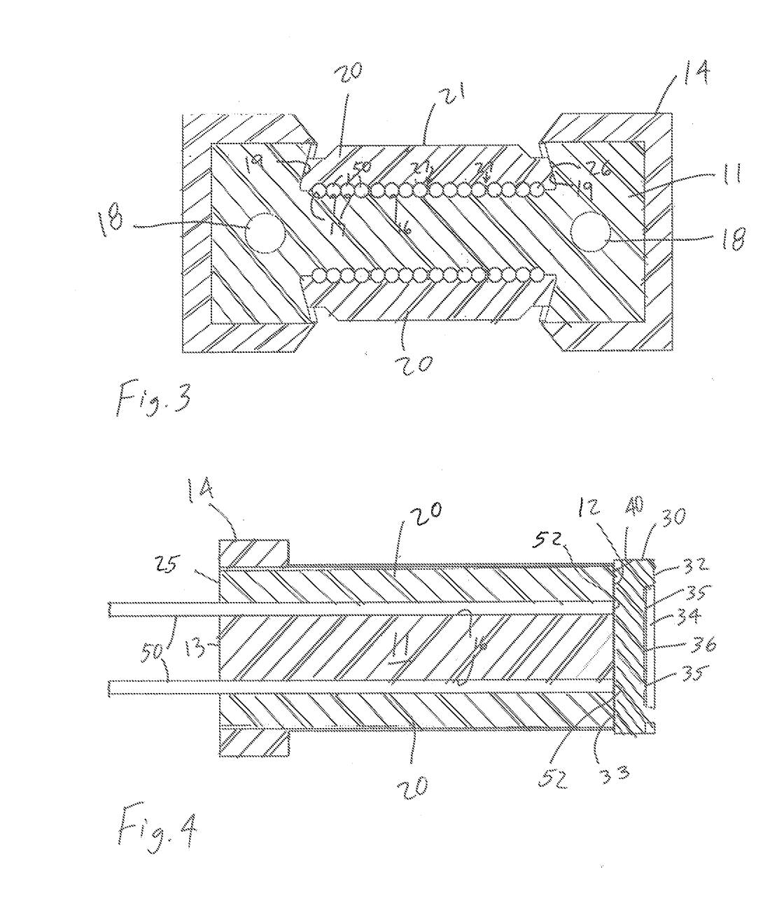

Referring to FIGS. 1-4, a multi-fiber lensed ferrule assembly 10 is illustrated. The ferrule assembly includes a ferrule body 11 having a plurality of optical fibers 50 secured thereto. A light or beam expanding element such as lens plate 30 may be fixed to the ferrule body 11. As depicted, ferrule assembly 10 includes two rows of 16 optical fibers 50 although the ferrule assembly may be configured to receive greater or fewer optical fibers if desired.

Ferrule body 11 is generally rectangular and has a generally planar front face 12 and a generally planar rear face 13. A generally rectangular flange 14 extends around the ferrule body 11 adjacent the rear face 13. Flange 14 may be used to facilitate mounting of the ferrule assembly 10 within another component such as a housing (not shown). A pair of oppositely facing optical fiber receiving nests 15 extend between the front face 12 and the rear face 13. The optical fiber receiving nests 15 are configured to receive the optical fibers 50 in a side-by-side configuration with each of the optical fibers being generally parallel to each other. Each optical fiber receiving nest 15 has an optical fiber engaging or registration surface 16 for positioning and supporting each optical fiber 50 positioned within the optical fiber receiving nest 15.

The registration surface 16 may include a plurality of arcuate or scalloped sections 17. Each arcuate section 17 supports one of the optical fibers 50. If the optical fibers 50 are formed of a plastic material that is generally easily deformed, the arcuate sections 17 are desirable not only to align the optical fibers but also support the optical fibers and prevent their deformation. Deformation of the optical fibers (e.g., changing their cross-section from circular to oval or creating a flat surface) may negatively impact the optical performance of such optical fiber. If the optical fibers 50 inserted into the ferrule body 11 are formed of glass, the arcuate section 17 may not be necessary for supporting the optical fibers to prevent deformation but may still be useful for accurate positioning of each optical fiber.

Ferrule body 11 may include a pair of alignment holes 18 that extend rearwardly through the front face 12. The alignment holes are positioned on the horizontal centerline of the front face 12. The alignment holes 18 may be generally cylindrical and extend through the ferrule body 11 between the front face 12 and rear face 13. The alignment holes 18 are configured to receive a post (not shown) therein to facilitate alignment when mating a pair of optical fiber assemblies.

An alignment cover 20 is configured to be received within each optical fiber receiving nest 15 to secure the optical fibers 50 within the optical fiber receiving nest 15. Each alignment cover 20 may be generally rectangular with an outer surface 21 and an oppositely facing inner surface 22. The outer surface 21 may be generally planar and the inner surface 22 may include a plurality of arcuate or scalloped sections 23 that correspond to the arcuate section 17 of the optical fiber receiving nest 15 to position and support the optical fibers 50. As with the arcuate sections 17, when securing plastic optical fiber 50, it may desirable to distribute the forces on the optical fibers to reduce deformation of such fibers.

If desired, the optical fiber receiving nests 15 and the alignment covers 20 may be tapered to facilitate assembly of the alignment cover 20 to the ferrule body 11. More specifically, the optical fiber receiving nest may be tapered from the front face 12 of the ferrule body 11 to the rear face 13 so that the optical fiber receiving nest 15 is slightly wider adjacent the front face as compared to the rear face (FIG. 5). Similarly, the alignment cover 20 may be tapered from its front face 24 to its rear face 25 so that the alignment cover is slightly wider adjacent the front face as compared to the rear face. As such, the alignment cover 20 is narrower adjacent its rear face 25 than the optical fiber receiving nest 15 adjacent its front face 12. This configuration permits the alignment cover 20 to be inserted from the front face 12 of the ferrule body 11 and moved rearwardly towards the rear face 13 until the sidewalls 26 of the alignment cover 20 fully engage the inner walls 19 of the ferrule body 11.

The inner walls 19 of the ferrule body 11 and the sidewalls 26 of alignment cover 20 may be sloped so that insertion of the alignment cover 20 into the optical fiber receiving nest 15 secures the optical fibers in place and the alignment covers do not require any additional latch mechanisms. If desired, the inner walls 19 of the ferrule body 11 and the sidewalls 26 of the alignment cover 20 may also taper or slope downward so that sliding movement of the alignment cover 20 into the optical fiber receiving nest 15 also moves the inner surface 22 of the alignment cover 20 towards the optical fiber registration surface 16 of the optical fiber receiving nest 15.

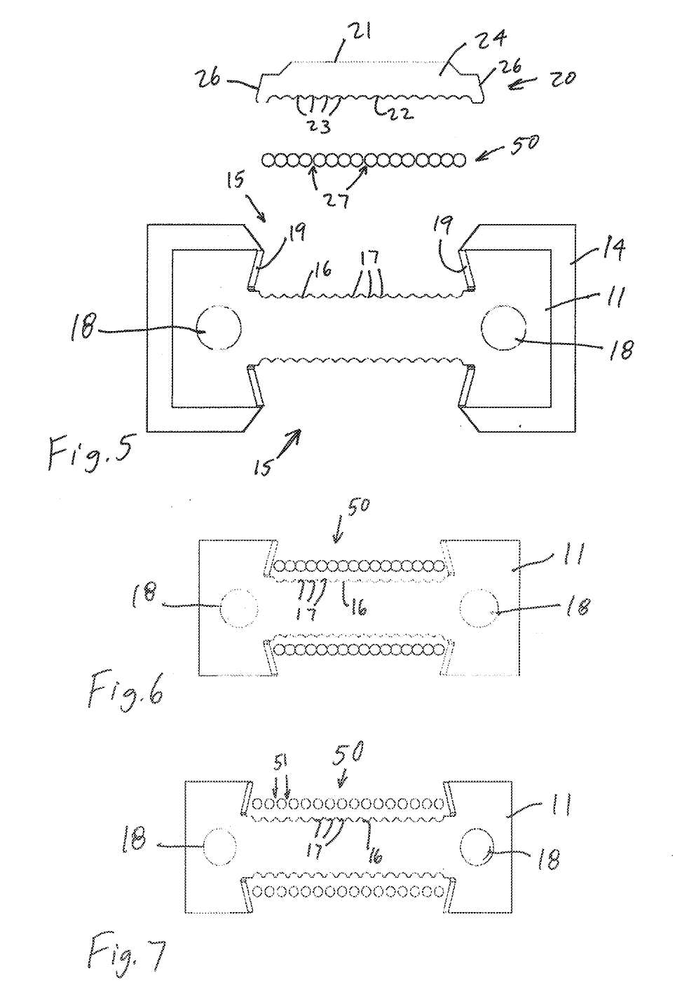

Each of the arcuate sections 17 of the optical fiber receiving nest 15 is aligned with one of arcuate sections 23 of the alignment cover 20. The spacing of the arcuate sections 17 along the registration surface 16 of optical fiber receiving nest 15 and the spacing of the arcuate sections 23 along the inner surface 22 of the alignment cover 20 may be set as desired. In one embodiment, as depicted in FIG. 5, the arcuate sections 17 and arcuate sections 23 are configured so that arrays of four optical fibers 50 are grouped together with a relatively small space or gap 27 between the groups of optical fibers. This may be desirable to facilitate the termination of plastic optical fibers. In other embodiments, the arcuate sections 17 and arcuate sections 23 may be uniformly spaced apart so that the optical fibers 50 are uniformly spaced either with adjacent optical fibers touching each other (FIG. 6) or with a gap 51 between adjacent optical fibers (FIG. 7).

Ferrule body 11 and the alignment covers 20 may be formed of a resin capable of being injection molded such as polyphenylene sulfide or polyetherimide and may include an additive such as silica (SiO2) to increase the strength and stability of the resin. Other materials may be used as desired.

Lens plate 30 is generally rectangular and has a front face 32 and a rear face 33. Lens plate 30 may be formed of an optical grade resin that is capable of being injection molded with a refractive index closely matching that of the optical fibers 50. In one example, the lens plate may be formed of Ultem®. A recess 34 may be centrally located in the front face 32 of the lens plate 30 and includes a plurality of lens elements 35. One lens element is aligned with each optical fiber 50 when the lens plate 30 is secured to the front face 12 of the ferrule body 11. In the depicted embodiment, the lens elements 35 are of the cross-focusing type and include a convex shape (FIG. 4) projecting from the bottom surface 36 of recess 34 towards the front face 32 of lens plate 30. The rear face 33 of lens plate 30 may be positioned adjacent the front face 12 of ferrule body 11 with an end face 52 of each optical fiber 50 engaging the rear face 33 of lens plate 30.

Lens plate 30 may include a pair of cylindrical guide holes or receptacles 37 that are configured to be aligned with the alignment holes 18 of ferrule body 11. Each guide hole 37 may be configured to have a diameter that matches or is larger than that of the alignment holes 18 of ferrule body 11.

Lens plate 30 may have a pair of circular spacers or pedestals (not shown) projecting from rear face 33 with one surrounding each guide hole 37. The length of the spacers may be chosen so as to define a consistent and predetermined distance or gap 38 between the front face 12 of ferrule body 11 and the rear face 33 of lens plate 30. A reservoir 40 may be provided in the upper and lower surfaces 41 of lens plate 30 to facilitate the application of an index-matched medium such as an epoxy between the end faces 52 of the optical fibers 50 and the rear face 33 of the lens plate 30.

During assembly, a plurality of optical fibers 50 are positioned within one of the optical fiber receiving nest 15 of ferrule body 11. Each of the optical fibers 50 are positioned so as to engage the arcuate sections 17 of the optical fiber registration surface 16 within the optical fiber receiving nest 15.

An alignment cover 20 is positioned adjacent optical fiber receiving nest 15 with the rear face 25 of the alignment cover 20 generally adjacent the front face 12 of the ferrule body 11.

The alignment cover 20 is positioned so that each of the arcuate sections 23 of the inner surface 22 is aligned with one of the optical fibers 50. The alignment cover 20 may then be moved relative to the ferrule body from the front face 12 towards the rear face 13. The tapered inner walls 19 of the ferrule body 11 and tapered sidewalls 26 of alignment cover 20 will cause the alignment cover 20 to be secured in place with the optical fibers 50 sandwiched between the ferrule body 11 and the alignment cover 20. If desired, an adhesive such as epoxy may be applied to the optical fibers 50 within the optical fiber receiving nest 15 and to inner surface 22 of alignment cover 20 to further secure the ferrule body 11, the alignment cover 20 and the optical fibers 50. If the ferrule body 11 includes an additional optical fiber receiving nest 15, the process may be repeated to secure optical fibers 50 within such optical fiber receiving nest 15.

After the optical fibers 50 are secured within the optical fiber receiving nests 15 of the ferrule body 11, the optical fibers may be cleaved or terminated generally adjacent front face 12. Additional processing of the end faces 52 of the optical fibers 50 may be performed if desired. For example, if the optical fibers are made of glass, it may be desirable to polish the end faces 52 as is known in the art. The lens plate 30 may then be secured to the ferrule body 11 by applying an adhesive between the front face 12 of the ferrule body and the rear face 33 of the lens plate 30. In one embodiment, a fixture (not shown) may be used to position the lens plate 30 adjacent the front face 12 of the ferrule body 11 and an adhesive such as epoxy applied to the reservoir 40 adjacent the upper and lower surfaces 41 of the lens plate 30. The adhesive will travel from the reservoir 40 and along the gap between the front face 12 of ferrule body 11 and the rear face 33 of lens plate 30 to secure the lens plate to the ferrule body and create a uniform gap 42 between the end faces 52 of the optical fibers 50 and the lens elements 35 of the lens plate. In many instances, it may be desirable to utilize an adhesive having an index of refraction that generally matches that of the lens plate 30 and the optical fibers 50 to maximize light transmission.

In an alternate embodiment, lens plate 30 may be eliminated so that the optical fibers 50 of one ferrule assembly 10 are mated directly with another ferrule assembly (not shown) having optical fibers aligned with the optical fibers 50 of the depicted ferrule assembly.

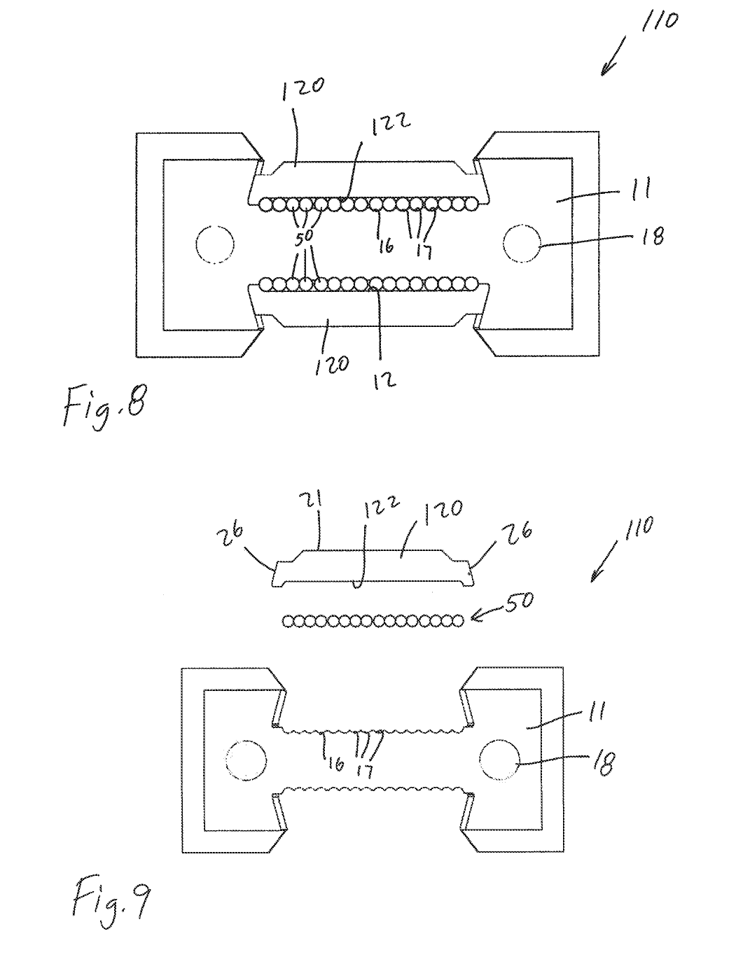

Referring to FIGS. 8-10, an alternate embodiment of a ferrule assembly 110 is depicted. Like reference numbers are used to depict like components and the description thereof is not repeated herein. In FIGS. 8-10, the alignment cover 120 is modified but the ferrule assembly 110 is otherwise generally identical to the ferrule assembly 10 described above. More specifically, the inner surface 122 of the alignment cover 120 is generally planar and engages the optical fibers 50 along the plane of the inner surface.

In some instances, such as when utilizing certain types of plastic optical fiber 50, it may be desirable to provide additional support to the surfaces of the optical fibers 50 adjacent the generally planar inner surface 22. As depicted in FIG. 10, the optical fibers 50 may be secured by a material such as a conformal coating 53 that fully or partially surrounds the optical fibers to support and position the optical fibers. Such material has the additional benefit of distributing the force from the generally planar inner surface 122 to reduce the likelihood that the plastic optical fibers 50 will be deformed. This configuration also simplifies the loading of the optical fibers 50 into the optical fiber receiving nest 15.

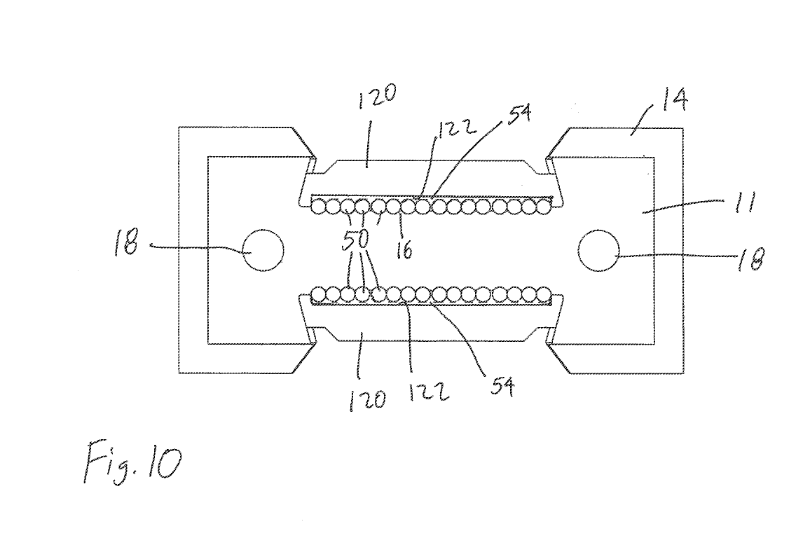

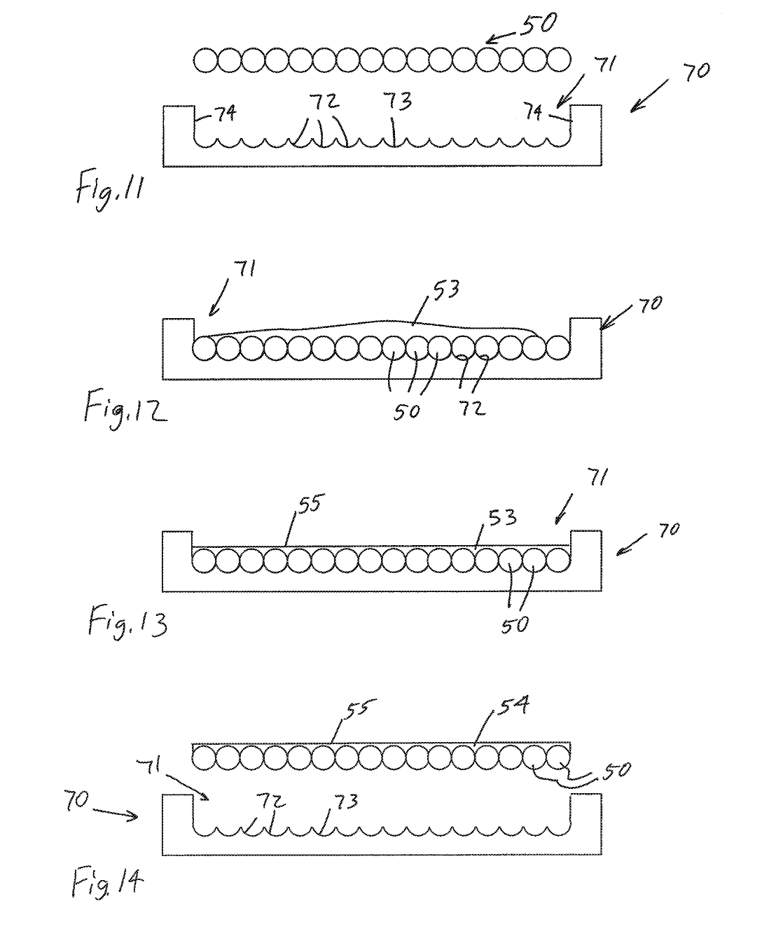

To form such a matrix or connecting member 54, a fixture 70 (FIG. 11) may be provided. The fixture 70 may include a fiber receiving nest 71 having a plurality of arcuate or scalloped sections 72 on a lower surface 73 thereof. The optical fiber receiving nest 71 may have sidewalls 74 defining an outer boundary of the connecting member 54 to be formed within the fixture 70.

As shown in FIG. 12, the optical fibers 50 may be positioned within the optical fiber receiving nest 71 of fixture 70 with a lower surface of the optical fibers engaging each of the arcuate sections 72 to align the optical fibers as desired. A conformal coating 53 may be applied to the upper surfaces of the optical fibers 50. In one embodiment, the conformal coating 53 may be chosen so as to have a viscosity that is low enough that it creates a generally flat, self-leveling surface 55 above the optical fibers 50 yet the viscosity is high enough that the conformal coating does not flow or leak substantially between the adjacent optical fibers 50 (FIG. 13). After the conformal coating is cured or otherwise set, the assembly of the optical fibers 50 and the connecting member 54 may be removed as a single unit from the fixture 70 (FIG. 14).

As depicted in FIG. 10, the assembly of the optical fibers 50 and the connecting member 54 may be inserted into an optical fiber receiving nest 15 of a ferrule body 11 and an alignment cover 120 having a generally planar inner surface 122 positioned within the optical fiber receiving nest 15 so that the generally planar surface 55 of the connecting member 54 is engaged by the generally flat planar inner surface 122 of alignment cover 120. Depending on the thickness of the connecting member 54, it may be desirable to reduce the thickness of the cover 120 (as compared to that of FIGS. 8-9) so that excessive forces are not applied to the connecting member. An adhesive such as epoxy may be applied within optical fiber receiving nest 15 as described above to secure the ferrule body 11, optical fibers 50 and the alignment cover 120 if desired. The force applied by the alignment cover 120 will be distributed by the generally planar surface 55 of the connecting member and thus minimize any deformation of or distortion to the optical fibers 50. This configuration may be particularly useful when used with plastic optical fibers that are easily deformed.

In another alternate embodiment, both the optical fiber registration surface 16 of the optical fiber receiving nest 15 as well as the inner surface 122 of alignment cover 120 may be generally planar. In other words, neither the ferrule body 11 nor the alignment cover 120 would include any arcuate sections for aligning the optical fibers 50. In such case, the alignment may be achieved through the use of the connecting member 54 described above or with a registration member (not shown) associated with the connecting member 54.

While a preferred embodiment of the Present Disclosure is shown and described, it is envisioned that those skilled in the art may devise various modifications without departing from the spirit and scope of the foregoing Description and the appended Claims.

What is claimed is:

1. An optical fiber ferrule assembly comprising:
a plurality of generally parallel optical fibers, each optical fiber having an axis;
a ferrule body having a front face and an oppositely facing rear face, an optical fiber receiving nest configured to receive a plurality of generally aligned optical fibers, the axes of the optical fibers being generally parallel to an optical fiber axis, the optical fiber receiving nest opening laterally relative to the optical fiber axis to facilitate insertion of the optical fibers into the optical fiber receiving nest, the optical fiber receiving nest having an optical fiber registration surface, the optical fiber registration surface having a plurality of arcuate surfaces, each arcuate surface being configured to engage one of the optical fibers for aligning the optical fibers relative to the optical fiber axis; and
a cover secured to the ferrule body to secure the optical fibers within the optical fiber receiving nest.

2. The optical fiber ferrule assembly of claim 1, wherein the optical fibers are arranged in a side-by-side configuration.

3. The optical fiber ferrule assembly of claim 2, wherein each optical fiber is in contact with an adjacent optical fiber.

4. The optical fiber ferrule assembly of claim 1, wherein the arcuate surfaces are scalloped-shaped to define a plurality of arcuate channels extending generally parallel to the optical fiber axis.

5. The optical fiber ferrule assembly of claim 1, wherein the cover is positioned in the optical fiber receiving nest.

6. The optical fiber ferrule assembly of claim 5, wherein the optical fiber receiving nest and the cover are configured to lock the cover in the optical fiber receiving nest.

7. The optical fiber ferrule assembly of claim 1, wherein the cover includes at least one alignment member for aligning the optical fibers relative to the optical fiber axis.

8. The optical fiber ferrule assembly of claim 1, wherein the ferrule body includes a second optical fiber receiving nest configured to receive a second plurality of generally aligned optical fibers, the second plurality of optical fibers being generally parallel to the optical fiber axis, the second optical fiber receiving nest opening laterally relative to the optical fiber axis in a direction generally opposite the optical fiber receiving nest to facilitate insertion of the second plurality of optical fibers into the second optical fiber receiving nest, the second optical fiber receiving nest having a second optical fiber registration surface including at least one second alignment member for aligning the second optical fibers relative to the optical fiber axis, and a second cover secured to the ferrule body to secure the second plurality of optical fibers within the second optical fiber receiving nest.

9. The optical fiber ferrule assembly of claim 1, further including a beam expanding element generally adjacent the front face of the ferrule body, the beam expanding element having a lens array aligned with the optical fibers of ferrule body and an index matched medium between the index matched medium and end faces of the optical fibers.

10. An optical fiber ferrule comprising:
a ferrule body;
a front face and an oppositely facing rear face; and
an optical fiber receiving nest extending generally between the front face and the rear face and being configured to receive a plurality of generally aligned optical fibers, axes of the optical fibers being generally parallel to an optical fiber axis, the optical fiber receiving nest opening laterally relative to the optical fiber axis to facilitate lateral insertion of the optical fibers into the optical fiber receiving nest, the optical fiber receiving nest having an optical fiber registration surface including a plurality of arcuate surfaces, each arcuate surface being configured to engage one of the optical fibers.

11. The optical fiber ferrule of claim 10, further including a cover secured to the ferrule body to secure the optical fibers within the optical fiber receiving nest.

12. The optical fiber ferrule of claim 10, wherein the arcuate surfaces are scalloped-shaped to define a plurality of arcuate channels extending generally parallel to the optical fiber axis.

13. A method of assembling an optical fiber ferrule assembly comprising:
providing a ferrule body having a front face, an oppositely facing rear face and an optical fiber receiving nest positioned between the front face and the rear face, the optical fiber receiving nest having an optical fiber registration surface including a plurality of arcuate channels extending generally between the front face and the rear face;
aligning an optical fiber with each of the arcuate channels;
moving the optical fibers into the optical fiber receiving nest opening and laterally against the plurality of arcuate surfaces to form a generally parallel array of optical fibers; and
securing the array of optical fibers within the optical fiber receiving nest.

14. The method of assembling an optical fiber ferrule assembly of claim 13, further including terminating the plurality of optical fibers generally adjacent the front face.

15. The method of assembling an optical fiber ferrule assembly of claim 13, further including arranging the optical fibers in a side-by-side configuration.

16. The method of assembling an optical fiber ferrule assembly of claim 13, further including arranging the optical fibers so that each optical fiber is in contact with an adjacent optical fiber.

17. The method of assembling an optical fiber ferrule assembly of claim 13, further including securing a cover to the ferrule body to secure the optical fibers within the optical fiber receiving nest.

18. The method of assembling an optical fiber ferrule assembly of claim 17, further including positioning the cover in the optical fiber receiving nest.

19. The method of assembling an optical fiber ferrule assembly of claim 17, further including aligning each of the optical fibers with an arcuate channel on an inner surface of the cover.

20. The method of assembling an optical fiber ferrule assembly of claim 13, further including securing a beam expanding element generally adjacent the front face of the ferrule body.
